(19) United States
(12) Patent Application Publication
(10) Pub. No.: US 2026/0361994 A1
(43) Pub. Date: Nov. 12, 2026

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: SHIORI SAKAI, Kanagawa (JP)

(21) Appl. No.: 19/659,203

(22) Filed: Apr. 27, 2026

(30) Foreign Application Priority Data
May 9, 2025 (JP) 2025-078878

(51) Int. Cl. H04N 23/62; H04N 23/69; H04N 23/695

(52) U.S. Cl. CPC H04N 23/62; H04N 23/69; H04N 23/695

(57) ABSTRACT

A control unit controls a posture or a zoom magnification of an imaging apparatus. A setting unit sets a movable range that enables control of the posture or the zoom magnification of the imaging apparatus from within an entire driving range of the posture or the zoom magnification of the imaging apparatus. A limiting unit limits control of the posture or the zoom magnification of the imaging apparatus by the control unit to within the movable range. A first determination unit determines whether or not a user is a user who is permitted to set the movable range. The first display control unit performs display of the movable range and the entire driving range for a user determined to be a user who is permitted to set the movable range.

### BACKGROUND

### FIELD OF THE TECHNOLOGY

The present disclosure relates to an information processing apparatus, an information processing method, and a non-transitory computer-readable storage medium.

### DESCRIPTION OF THE RELATED ART

In recent years, pan-tilt-zoom cameras capable of remotely driving control of a pan direction, a tilt direction, and a zoom with respect to an imaging unit of a camera have been used in video production sites. There is also a function for setting a movable range of a pan mechanism, a tilt mechanism, and a zoom mechanism of a camera to perform operations within a limited range. By limiting the movable range, a user can perform operations without being conscious of a range that the user does not wish to capture.

However, users are broadly classified into administrator users who perform camera management and settings, and general users who only perform operations, and information required during camera operation differs depending on those user attributes. For example, since an administrator user mainly performs camera settings, it is desirable that the presence or absence of a movable range setting be clearly indicated. On the other hand, since a general user only performs operations, information outside the movable range where capturing is not permitted is not necessary. In current products that show only the movable range in a viewer regardless of user authority, operability is poor because it is necessary to perform page transition in order to confirm the movable range setting.

Japanese Patent Laid-Open No. 2001-157203 discloses a technology for displaying, together on a viewer, a PT movable range and an operating range in which operation is possible as a camera capability. Further, Japanese Patent Laid-Open No. 2018-125699 discloses a means for displaying a warning when a set PT movable range is reached.

In the technology described in Japanese Patent Laid-Open No. 2001-157203, since the display is not changed for each user authority and both the movable range set by the user and the operating range as a camera capability are displayed, there was a problem of making a general user who only performs operations conscious of a range that should not be captured. Further, in the technology described in Japanese Patent Laid-Open No. 2018-125699, only a warning is displayed when a movable range end is reached, and the presence or absence of the movable range setting cannot be confirmed without performing PT operations.

### SUMMARY

According to an embodiment of the present disclosure, an information processing apparatus that provides an appropriate screen for a user of an imaging apparatus is provided.

According to one embodiment of the present disclosure, an information processing apparatus comprises: a control unit configured to control a posture or a zoom magnification of an imaging apparatus; a setting unit configured to set a movable range that enables control of the posture or the zoom magnification of the imaging apparatus from within an entire driving range of the posture or the zoom magnification of the imaging apparatus; a limiting unit configured to limit control of the posture or the zoom magnification of the imaging apparatus by the control unit to within the movable range; a first determination unit configured to determine whether or not a user is a user who is permitted to set the movable range; and a first display control unit configured to control display of the movable range, wherein the first display control unit performs display of the movable range and the entire driving range for a user determined to be a user who is permitted to set the movable range.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram showing an example of a network configuration including an imaging apparatus and an information processing apparatus.

FIG. 2 is a diagram showing an example of a hardware configuration of the imaging apparatus.

FIG. 3 is a diagram showing an example of a hardware configuration of the information processing apparatus.

FIG. 4 is a diagram showing an example of a viewer of the information processing apparatus according to Embodiment 1.

FIG. 5 is a diagram showing an example of information processing by the information processing apparatus according to Embodiment 1.

FIG. 6A and FIG. 6B are diagrams for describing display of a movable range and an entire driving range.

FIG. 7 is a diagram showing an example of information processing by the information processing apparatus according to Embodiment 2.

FIG. 8A and FIG. 8B are diagrams for describing lighting display control.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Embodiment 1

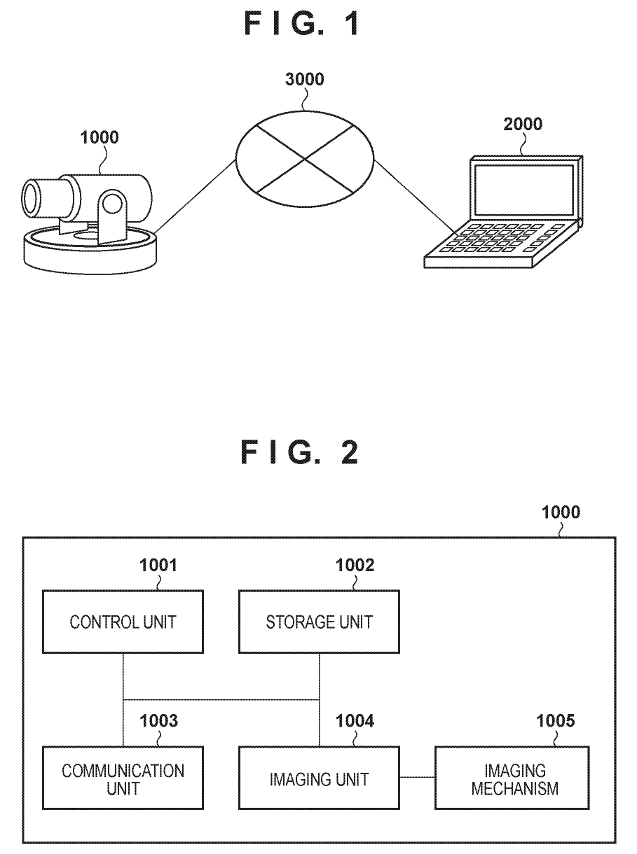

FIG. 1 is a network configuration diagram including an imaging apparatus (video transmission apparatus) 1000 and an information processing apparatus 2000 according to the present embodiment. The information processing apparatus 2000 is a client apparatus (video reception apparatus) according to the present embodiment. In the example of FIG. 1, a video system is constructed by the imaging apparatus 1000 and the information processing apparatus 2000 being communicatably connected via a network 3000. Note that the configuration shown in FIG. 1 is an example, and other apparatuses may be used. For example, a delivery server may be provided outside the imaging apparatus 1000, and the delivery server may have a function as a video transmission apparatus that transmits video captured by the imaging apparatus 1000 to the information processing apparatus 2000.

The imaging apparatus 1000 acquires a captured image (video) and transmits the acquired video to the information processing apparatus 2000. The imaging apparatus 1000 can acquire video by an imaging function provided in a general imaging apparatus, and a detailed description of an imaging mechanism 1005 that acquires video in the present embodiment is omitted. Further, as described above, the imaging apparatus 1000 is connected to be mutually communicatable with the information processing apparatus 2000 via the network 3000.

The information processing apparatus 2000 according to Embodiment 1 controls a posture or a zoom magnification of the imaging apparatus 1000, and sets a movable range that enables control of the posture or the zoom magnification of the imaging apparatus from within an entire driving range of the posture or the zoom magnification of the imaging apparatus. Further, the information processing apparatus 2000 limits control of the posture or the zoom magnification of the imaging apparatus 1000 to within the set movable range. Furthermore, the information processing apparatus 2000 determines whether or not a user is a user who is permitted to set the movable range, and controls display of the movable range according to whether or not the setting of the movable range is permitted. In particular, in the present embodiment, the information processing apparatus 2000 performs display of both the movable range and the entire driving range for a user determined to be a user who is permitted to set the movable range. Details of processing by the information processing apparatus 2000, including details of the control of the display of the movable range, will be described later.

FIG. 2 is a block diagram showing an example of a hardware configuration of the imaging apparatus 1000. The imaging apparatus 1000 according to the present embodiment includes a control unit 1001, a storage unit 1002, a communication unit 1003, an imaging unit 1004, and an imaging mechanism 1005.

The control unit 1001 is, for example, a CPU, and performs overall control of the imaging apparatus 1000. The storage unit 1002 is used as a storage area for various data. The storage unit 1002 is used, for example, as a storage area for programs mainly executed by the control unit 1001, or data such as a pan/tilt movable control range or a zoom movable control range to be described later. Further, the storage unit 1002 may function as a work area during program execution.

The communication unit 1003 performs transmission and reception of various information with the information processing apparatus 2000 via the network 3000. The communication unit 1003 performs, for example, reception of change contents of each setting value or control commands from the information processing apparatus 2000, or transmission of responses to each command to the information processing apparatus 2000 or transmission of various data such as a movable control range stored in the storage unit 1002.

The imaging unit 1004 performs acquisition of video via the imaging mechanism 1005. Here, the imaging unit 1004 converts an analog signal acquired by imaging an image of a subject formed by the imaging mechanism 1005 into digital data, and stores it in the storage unit 1002 as a captured image.

The imaging mechanism 1005 is configured by an imaging optical system including a lens, an imaging element, or the like, or a pan-tilt-zoom mechanism that controls an imaging range such as an imaging direction or an angle of view. In this way, the imaging mechanism 1005 according to the present embodiment can control the posture or the zoom magnification of the imaging apparatus 1000.

Note that the configuration of the imaging apparatus 1000 is not limited to that shown in FIG. 2. For example, the imaging apparatus 1000 may include an audio input unit and an audio output unit that perform input and output of audio, may have various other configurations, and some configurations may be omitted.

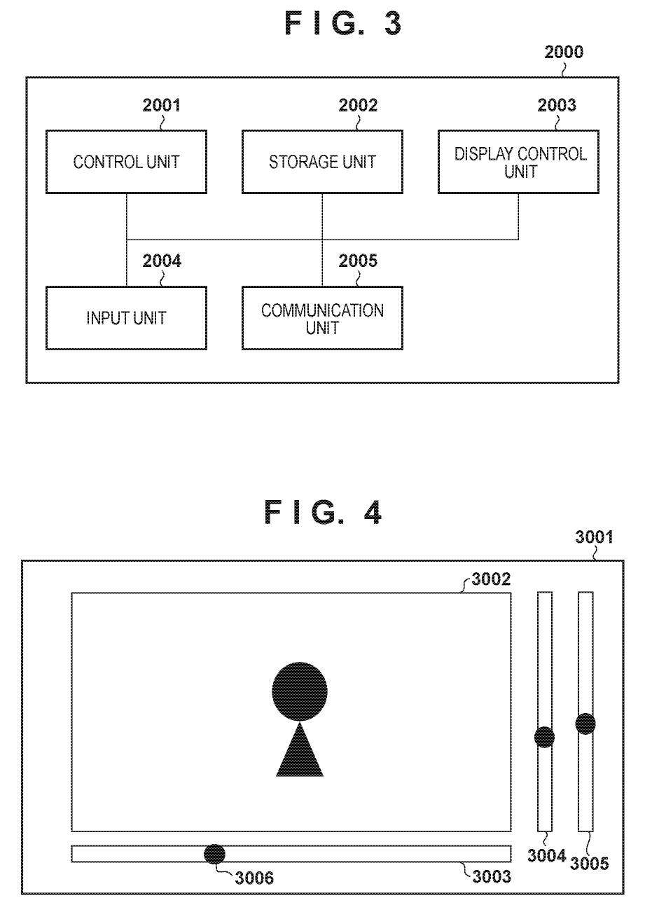

FIG. 3 is a block diagram showing an example of a hardware configuration of the information processing apparatus 2000. The information processing apparatus 2000 according to the present embodiment includes a control unit 2001, a storage unit 2002, a display control unit 2003, an input unit 2004, and a communication unit 2005.

The control unit 2001 is, for example, a CPU, and performs overall control of the information processing apparatus 2000. The storage unit 2002 is used as a storage area for various data. The storage unit 2002 is used, for example, as a storage area for programs mainly executed by the control unit 2001, or data such as connectable camera information currently existing on the network 3000. Further, the storage unit 2002 may function as a work area during program execution.

The display control unit 2003 performs display control of various information using a display unit (not shown). The display control unit 2003 according to the present embodiment performs display of a set movable range, as will be described in detail later. Further, the display control unit 2003 can perform display control of, for example, various setting screens, a display screen for data acquisition, a viewer for video received from the imaging apparatus 1000, or various messages. Here, the display unit can be, for example, an LCD display or an organic EL display.

The input unit 2004 accepts operations by a user and transfers contents of the accepted user input to the control unit 2001. The input unit 2004 can be, for example, a button, a touch panel, or a mouse.

The communication unit 2005 performs transmission and reception of various information with the imaging apparatus 1000 via the network 3000. The communication unit 2005 can, for example, transmit a command such as a movement request to the imaging apparatus 1000, or receive a response to each change command from the imaging apparatus 1000.

Note that the configuration of the information processing apparatus 2000 is not limited to that shown in FIG. 3. For example, the information processing apparatus 2000 may include a different display unit that displays an image received from the imaging apparatus 1000, may include an image analysis processing unit that performs analysis of a captured image, may include an image storage unit that stores received images, may have various other configurations, and some configurations may be omitted.

Next, a viewer 3001 will be described with reference to FIG. 4 as an example of a viewer for which display control is performed by the display control unit 2003.

The viewer 3001 displays a video display portion 3002, a slider bar 3003 that performs control of the imaging direction in the pan direction, a slider bar 3004 that performs control of the imaging direction in the tilt direction, and a slider bar 3005 that performs control of the zoom magnification. Further, a mark 3006 is superimposed and displayed as a slider on each slider bar. The video display portion 3002 displays video received from the imaging apparatus 1000.

The control unit 2001 according to the present embodiment performs control of the posture or the zoom magnification (pan, tilt, or zoom) of the imaging apparatus 1000. The control unit 2001 can perform control of the posture or the zoom magnification of the imaging apparatus 1000 according to, for example, the position of the slider (mark 3006) in each slider bar. Here, the mark 3006 moves according to user input, but it is not particularly limited to those operation contents. For example, the mark 3006 may move by pressing a button arranged in association with the slider bar (for example, a fixed amount per unit time), may move by pressing a mechanical button arranged outside the viewer, may move by a drag operation on the mark 3006 via a mouse cursor or the like, or may move according to a user operation on the video display portion 3002. When moving according to a user operation on the video display portion 3002, the mark 3006 may move so as to result in a suitable imaging range according to a click, drag-and-drop, or scroll operation on the video. Note that here, the imaging range (posture and zoom magnification) of the imaging apparatus 1000 is set according to the movement of the mark 3006 and reflected in real time, but for example, an imaging range according to the position of the mark 3006 may be transmitted to the imaging apparatus 1000 and the setting may be reflected in response to a reflection button (not shown) being pressed after the movement of the mark 3006.

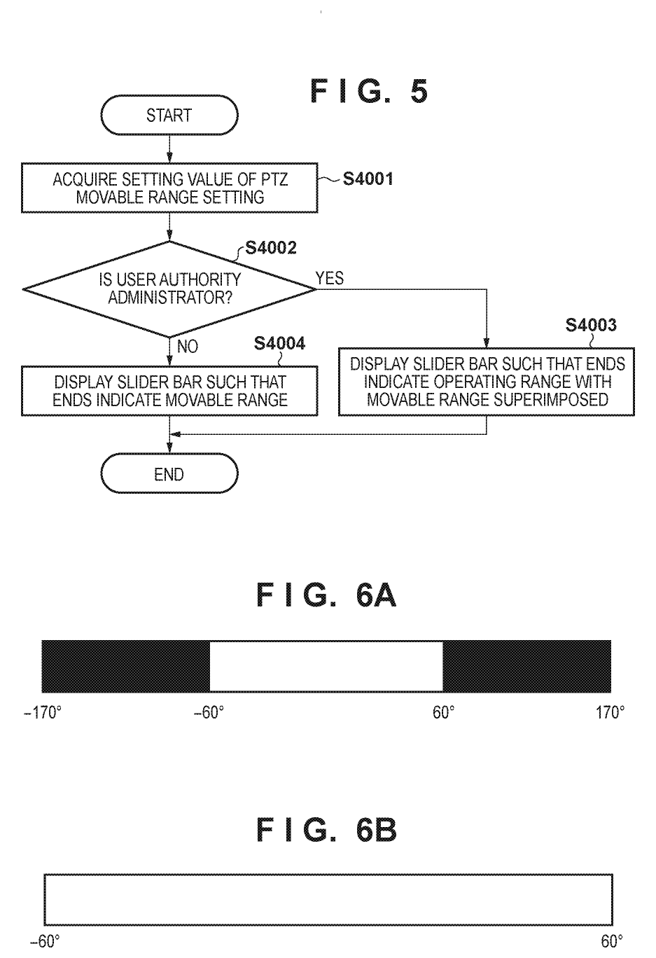

The information processing apparatus 2000 according to the present embodiment limits the operation of the posture or the zoom magnification of the imaging apparatus 1000 to within the movable range. For example, the information processing apparatus 2000 can limit the operation of the posture or the zoom magnification to within the movable range by displaying slider bars corresponding to the movable range as the slider bars 3003 to 3005 as shown in FIG. 4. Although a specific example will be described later with reference to FIG. 6B, a slider bar corresponding to the movable range is a slider bar in which both ends of the slider bar are made to correspond to both ends of the movable range. By accepting user input for such a slider bar, it becomes possible to provide a UI in a state where control of the imaging apparatus is limited to within the movable range.

Note that the viewer 3001 shown in FIG. 4 is an example, and is not particularly limited to such a configuration. For example, in the viewer 3001, the slider bars 3003 to 3005 may all be arranged horizontally, a UI such as a button for setting imaging characteristics such as exposure or white balance of the imaging apparatus 1000 may be additionally displayed, a part of the slider bars 3003 to 3005 may not be displayed, and various other displays may be performed.

Next, information processing performed by the information processing apparatus 2000 according to the present embodiment will be described with reference to the flowchart of FIG. 5. The processing shown in FIG. 5 shall start when a start operation of processing (for example, execution of operation of the viewer 3001 by the information processing apparatus 2000) is performed in the imaging apparatus 1000 or the information processing apparatus 2000.

In step S4001, the information processing apparatus 2000 performs setting of a movable range that enables control of the posture or the zoom magnification of the imaging apparatus 1000. The "movable range" in the present embodiment shall be a range in which control of the posture or the zoom magnification is enabled (permitted), which is set from within the entire driving range (the maximum operating range drivable in terms of the capability of the imaging apparatus 1000) of the posture or the zoom magnification of the imaging apparatus 1000. Here, the movable range shall be arbitrarily settable, but for example, it may be set as a predetermined fixed value, a registered value may be prepared for each user, and desired settings can be made. In the present embodiment, the information processing apparatus 2000 shall perform setting of the movable range by receiving a setting value of the movable range set in the imaging apparatus 1000.

In step S4002, the information processing apparatus 2000 determines whether or not the user is a user who is permitted to set the movable range. If the user is a user who is permitted to set the movable range, the process proceeds to step S4003, and if not, the process proceeds to step S4004. Here, for example, the information processing apparatus 2000 can perform login processing at the start of step S4002 or at the start of operation of the information processing apparatus 2000, and determine whether or not setting of the movable range is permitted for the user based on information associated with the logged-in user. For example, the storage unit 2002 may store authority information indicating whether the user is an "administrator user" or a "general user" who is not an administrator user in advance in association with each user, and the determination in step S4002 may be performed by reading the user authority information. Note that when multiple types of users exist in this way, different displays may be performed on a screen for executing login according to the determined type of user.

Note that the "user who is permitted to set the movable range" according to the present embodiment shall refer to a user to whom authority to set the movable range as described above is granted, and here, authority to set the movable range is granted only to an administrator user (administrator). In the following, when simply referring to as an "administrator", it shall refer to a user who is permitted to set such a movable range, but this is an example as described above, and authority to set the movable range may be granted to a user of a specific attribute different from administrator.

In step S4003, the information processing apparatus 2000 performs display of the movable range and the entire driving range for the user determined to be the administrator, and ends the processing of FIG. 5. Further, in step S4004, the information processing apparatus 2000 performs display of the movable range without performing display of the entire driving range for the user (general user) determined not to be the administrator, and ends the processing of FIG. 5. Here, the information processing apparatus 2000 shall perform display of the movable range and the entire driving range using the slider bar displayed in the viewer 3001 described above.

FIG. 6A and FIG. 6B are diagrams for describing display of the movable range and the entire driving range, and display of only the movable range, by the information processing apparatus 2000 according to the present embodiment. Here, for the slider bar 3003 that controls the imaging direction in the pan direction, an example of display of the movable range and the entire driving range for the administrator is shown in FIG. 6A, and an example of display of only the movable range for the general user is shown in FIG. 6B. In the present embodiment, it is assumed that the entire driving range in the pan direction of the imaging apparatus 1000 is -170° to +170°, and the movable range is set as -60° to +60°. In this case, ranges within which movement is not possible and where operation is limited exist as ranges of -170° to -60° and +60° to +170°.

In FIG. 6A, display is performed such that the two ends of the slider bar correspond to -170° (left end) and +170° (right end) of the entire driving range. Here, corresponding angles (-170° and +170°) are displayed below the two ends of the slider bar. Furthermore, in FIG. 6A, a range of -60° to +60° corresponding to the movable range is displayed in the center portion of the slider bar. Here, the color inside the slider bar is displayed in black for locations corresponding to the entire driving range, and displayed in white for locations corresponding to the movable range, being superimposed and displayed on the area of the entire driving range. In this way, the information processing apparatus according to the present embodiment can display the movable range and the entire driving range with different displays (here, different color coding).

As described above, in the present embodiment, display of only the movable range is performed for the general user. Therefore, in FIG. 6B, the entire slider bar is displayed in white such that the two ends of the slider bar correspond to -60° (left end) and +60° (right end) of the movable range.

Note that the modes of display of the movable range and the entire driving range shown in FIG. 6A and FIG. 6B are examples, and are not particularly limited in this way. For example, although the description was made assuming that the movable range and the entire driving range are displayed with different color coding in FIG. 6A, such color coding may not be performed, and these displays may be performed by displaying a divider line at the boundaries between the movable range and the entire driving range. Further, although the display was performed in a form where the movable range is superimposed on the entire driving range in FIG. 6A, each of these may be displayed in different areas. In this way, as long as the movable range and the entire driving range can be displayed, any display format can be adopted.

According to such a configuration, it becomes possible to set a movable range from within the entire driving range and perform control of display of such a movable range according to whether or not setting of the movable range is permitted for the user. In particular, display of the movable range and the entire driving range can be performed for the administrator, and display of only the movable range can be performed for the general user. Therefore, it becomes possible to provide an appropriate screen for the user of the imaging apparatus. In particular, it becomes possible to display a screen on which camera settings are easily performed for the administrator user, and to improve operability for the general user by displaying only the movable range on the viewer and suppressing unnecessary display.

### Embodiment 2

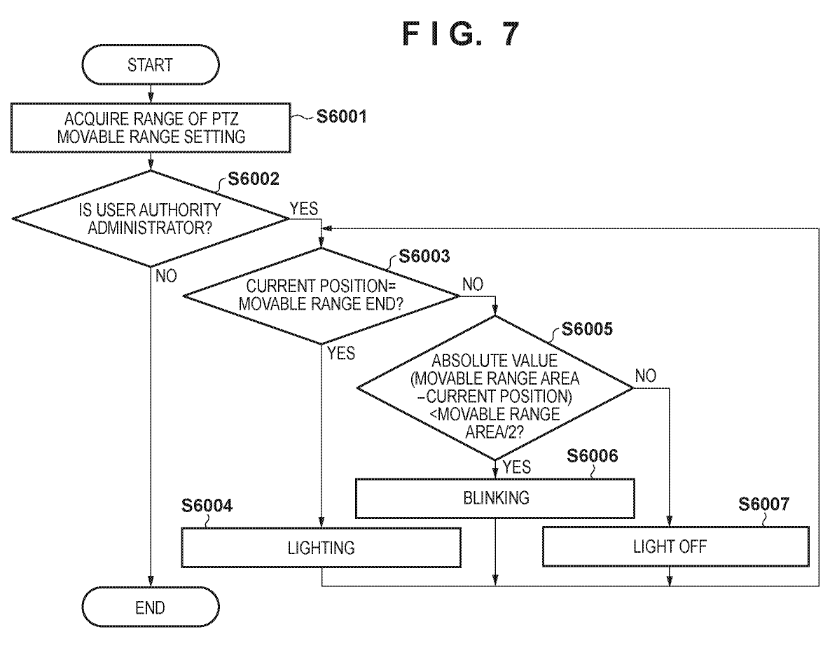

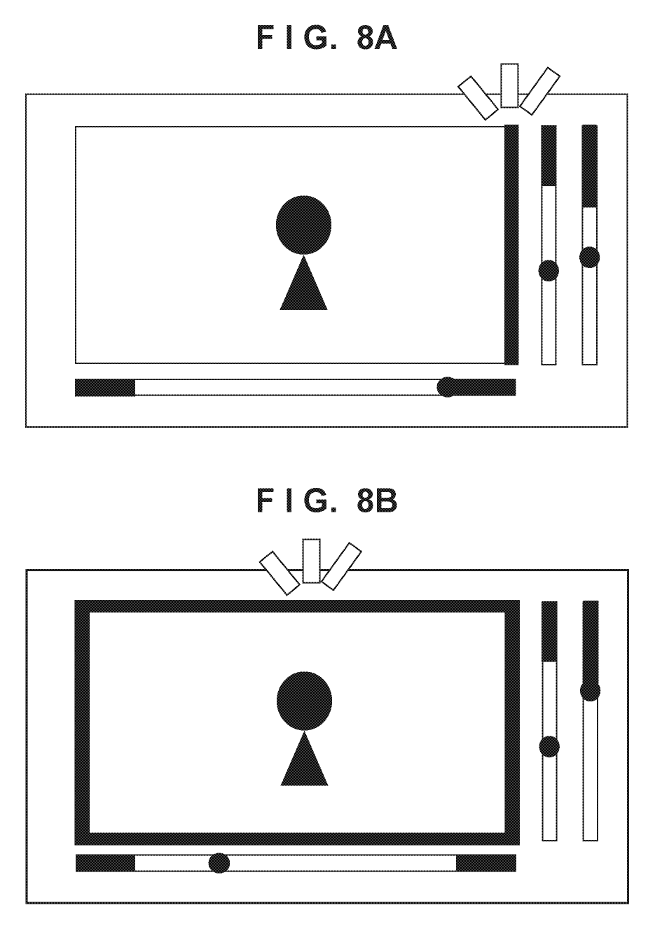

Hereinafter, an information processing apparatus according to Embodiment 2 will be described with reference to FIG. 7, and FIG. 8A and FIG. 8B. The video system according to the present embodiment includes the imaging apparatus 1000 and the information processing apparatus 2000 described in Embodiment 1 with reference to FIG. 1 to FIG. 3, and since it is capable of executing the same processing as Embodiment 1 such as displaying the viewer shown in FIG. 4, overlapping descriptions will be omitted.

The information processing apparatus 2000 displays video captured by the imaging apparatus 1000. Here, the information processing apparatus 2000 will be described below as displaying video captured by the imaging apparatus 1000 in the video display portion 3002 shown in FIG. 4. The information processing apparatus 2000 according to the present embodiment performs predetermined display control for a user determined to be the administrator in the display of video by the imaging apparatus 1000. In particular, the information processing apparatus 2000 according to the present embodiment determines, in the display of video by the imaging apparatus 1000, whether or not the posture or the zoom magnification of the imaging apparatus is located in the vicinity of an end of the movable range, and if determined to be located in the vicinity (in particular, if determined to have reached the movable range end), performs control of a predetermined display (described later). Hereinafter, such display control processing will be described with reference to FIG. 7, and FIG. 8A and FIG. 8B.

FIG. 7 is a flowchart showing an example of processing performed by the information processing apparatus 2000 according to the present embodiment. The processing shown in FIG. 7 shall start when a start operation of processing (for example, execution of operation of the viewer 3001 by the information processing apparatus 2000) is performed in the imaging apparatus 1000 or the information processing apparatus 2000.

In step S6001, the information processing apparatus 2000 performs setting of the movable range of the imaging apparatus 1000. In step S6002, the information processing apparatus 2000 determines whether or not the user is a user who is permitted to set the movable range. If the user is a user who is permitted to set the movable range, the process proceeds to step S6003, and if not, the processing of FIG. 7 ends. Step S6001 to step S6002 can be executed similarly to step S4001 to step S4002 of FIG. 5, and description here is omitted.

In step S6003, the information processing apparatus 2000 determines whether the current posture or zoom magnification of the imaging apparatus 1000 has reached the movable range end. Here, "reaching the movable range end" means that the posture or the zoom magnification of the imaging apparatus matches an upper limit or a lower limit set as the movable range. If the current posture or zoom magnification of the imaging apparatus 1000 has reached the movable range end, the process proceeds to step S6004, and if not, the process proceeds to step S6005.

In step S6004, the information processing apparatus 2000 performs second display control (the first display control will be described later), assuming that the posture or the zoom magnification of the imaging apparatus 1000 has reached the movable range end, and returns the process to step S6003. Here, as the second display control, lighting control of at least one of the ends (here, four-side ends) of the displayed video (for example, an end in a direction in which the pan or tilt has reached the movable range end) is performed. FIG. 8A and FIG. 8B are diagrams for describing such display control. In FIG. 8A, the posture of the imaging apparatus 1000 has reached the movable range end on the right side (+ side) in the pan direction, and a right end area of the video display portion 3002 is lit. This lighting is lighting in a predetermined color, and as long as it is lighting in a style where it can be seen to be lit, the color or the like is not particularly limited. As the color of the lighting, for example, any color such as orange, red, blue, green, or yellow can be used, and different colors may be used for the contour and the inside of the lit part. Further, this lighting may be made to be continuously lit as long as the posture or the zoom magnification of the imaging apparatus 1000 has reached the movable range end, or may be lighting that blinks at predetermined intervals while the posture or the zoom magnification of the imaging apparatus 1000 has reached the movable range end. Further, in FIG. 8A, description was made assuming that among the four-side ends of the video display portion 3002, the end in the direction in which the posture of the imaging apparatus 1000 has reached the movable range end is lit, but all four-side ends may be lit when the zoom magnification has reached the movable range end. FIG. 8B illustrates a state where all such four-side ends of the video display portion 3002 are lit.

Note that the area of the end to be lit here can be set arbitrarily. For example, the width of the end may be arbitrarily settable, and an area inside the video display portion 3002 may be used as the end, or an area outside may be used. Further, although this end is illustrated here as an area having a certain width, any shape such as, for example, a wave-like area can be adopted.

Furthermore, here, when the zoom magnification has reached the movable range end, all four-side ends are lit, and it is illustrated such that the lighting for each of the four-side ends is the same as the lighting when the posture has reached the movable range end. However, different displays may be performed when the posture of the imaging apparatus 1000 has reached the movable range end and when the zoom magnification has reached the movable range end. For example, lighting display in different colors may be performed or lighting display at different positions may be performed for when the posture of the imaging apparatus 1000 has reached the movable range end and when the zoom magnification has reached the movable range end.

In step S6005, the information processing apparatus 2000 determines whether the current posture or zoom magnification of the imaging apparatus 1000 is located in the vicinity of the movable range end. Here, "being located in the vicinity of the movable range end" means that the posture or the zoom magnification of the imaging apparatus exists within a predetermined threshold (arbitrarily settable) from an upper limit or a lower limit set as the movable range. If the current posture or zoom magnification of the imaging apparatus 1000 is located in the vicinity of the movable range end, the process proceeds to step S6006, and if not, the process proceeds to step S6007.

In step S6006, the information processing apparatus 2000 performs first display control, assuming that the posture or the zoom magnification of the imaging apparatus 1000 is located in the vicinity of the movable range end, and returns the process to step S6003. Here, the first display control shall be lighting control performing blinking at predetermined intervals, but for example, the first display control may be the same display control as the second display control. Also, for example, lighting in different colors may be performed in the lighting control when the posture or the zoom magnification of the imaging apparatus 1000 is located in the vicinity of the movable range end (first display control) and the lighting control when the posture or the zoom magnification of the imaging apparatus 1000 has reached the movable range end (second display control). In that case, for example, it is possible to perform lighting in green in the first display control and in red in the second display control. Also, for example, assuming the lighting color in the second display control as the maximum color density, in the first display control, display control of the lighting color may be performed such that the color density becomes lighter as the posture or the zoom magnification moves away from the movable range end.

In step S6007, if an end being lit exists, the information processing apparatus turns off the lighting of the end, and returns the process to step S6003. The processing shown in step S6003 to step S6007 ends when an end condition is satisfied (for example, when an end operation is performed in the information processing apparatus 2000).

According to such processing, it becomes possible to set a movable range from within the entire driving range and perform display according to whether or not the posture or the zoom magnification of the imaging apparatus is located in the vicinity of an end of such a movable range, according to whether or not setting of the movable range is permitted for the user. Therefore, for the administrator user, it becomes possible to display a screen on which it is easy to confirm proximity to and arrival at the end of the movable range while operating the camera.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-078878, filed May 9, 2025, which is hereby incorporated by reference herein in its entirety.

What is claimed is:

1. An information processing apparatus comprising:
a control unit configured to control a posture or a zoom magnification of an imaging apparatus;
a setting unit configured to set a movable range that enables control of the posture or the zoom magnification of the imaging apparatus from within an entire driving range of the posture or the zoom magnification of the imaging apparatus;
a limiting unit configured to limit control of the posture or the zoom magnification of the imaging apparatus by the control unit to within the movable range;
a first determination unit configured to determine whether or not a user is a user who is permitted to set the movable range; and
a first display control unit configured to control display of the movable range,
wherein the first display control unit performs display of the movable range and the entire driving range for a user determined to be a user who is permitted to set the movable range.

2. The information processing apparatus according to claim 1, wherein the first display control unit performs display of the movable range without performing display of the entire driving range for a user determined not to be a user who is permitted to set the movable range.

3. The information processing apparatus according to claim 1, wherein the first determination unit determines whether or not the user is a user who is permitted to set the movable range based on authority information associated with the user.

4. The information processing apparatus according to claim 3, wherein the first determination unit determines that the user is a user who is permitted to set the movable range when a specific attribute is associated with the user.

5. The information processing apparatus according to claim 4, wherein the first determination unit determines that the user is a user who is permitted to set the movable range when the user is set to be an administrator as the specific attribute.

6. The information processing apparatus according to claim 1, wherein the first display control unit displays the movable range and the entire driving range by a slider bar.

7. The information processing apparatus according to claim 1, further comprising:
a display unit configured to display an image captured by the imaging apparatus; and
a second display control unit configured to perform a predetermined display control in the image captured by the imaging apparatus displayed by the display unit for a user determined to be a user who is permitted to set the movable range.

8. The information processing apparatus according to claim 7, further comprising a second determination unit configured to perform determination as to whether or not the posture or the zoom magnification of the imaging apparatus is located in a vicinity of an end of the movable range,
wherein the second display control unit performs first display control for lighting an end of the image captured by the imaging apparatus when it is determined that the posture or the zoom magnification of the imaging apparatus is located in the vicinity of the end of the movable range.

9. The information processing apparatus according to claim 8, further comprising a third determination unit configured to perform determination as to whether or not the posture or the zoom magnification of the imaging apparatus has reached an end of the movable range,
wherein the second display control unit performs second display control for lighting the end of the image captured by the imaging apparatus when it is determined that the posture or the zoom magnification of the imaging apparatus has reached the end of the movable range.

10. The information processing apparatus according to claim 9, wherein the first display control is display control for continuously lighting the end of the image captured by the imaging apparatus, and the second display control is display control for causing the end of the image captured by the imaging apparatus to blink.

11. An information processing method comprising:
controlling a posture or a zoom magnification of an imaging apparatus;
setting a movable range that enables control of the posture or the zoom magnification of the imaging apparatus from within an entire driving range of the posture or the zoom magnification of the imaging apparatus;
limiting control of the posture or the zoom magnification of the imaging apparatus to within the movable range;
determining whether or not a user is a user who is permitted to set the movable range; and
controlling display of the movable range,
wherein in controlling of the display of the movable range, the movable range and the entire driving range is displayed for a user determined to be a user who is permitted to set the movable range.

12. A non-transitory computer-readable recording medium storing a program for causing a computer to execute an information processing method, the information processing method comprising:
controlling a posture or a zoom magnification of an imaging apparatus;
setting a movable range that enables control of the posture or the zoom magnification of the imaging apparatus from within an entire driving range of the posture or the zoom magnification of the imaging apparatus;
limiting control of the posture or the zoom magnification of the imaging apparatus to within the movable range;
determining whether or not a user is a user who is permitted to set the movable range; and
controlling display of the movable range,
wherein in controlling of the display of the movable range, the movable range and the entire driving range is displayed for a user determined to be a user who is permitted to set the movable range.
